(19) United States
(12) Patent Application Publication
(10) Pub. No.: US 2017/0346322 A1
(43) Pub. Date: Nov. 30, 2017

(54) TRANSPORTABLE ELECTRICAL ENERGY STORAGE AND SUPPLY SYSTEM

(71) Applicants: Shihab Kuran, Greenbrook, NJ (US); Yazen EL-Harasis, Watchung, NJ (US)

(72) Inventors: Shihab Kuran, Greenbrook, NJ (US); Yazen EL-Harasis, Watchung, NJ (US)

(21) Appl. No.: 15/607,443

(22) Filed: May 27, 2017

Related U.S. Application Data
(60) Provisional application No. 62/342,928, filed on May 28, 2016.
(60) Provisional application No. 62/342,963, filed on May 29, 2016.

(51) Int. Cl. H02J 7/00; H01M 2/20; H01M 10/48; H01M 2/10

(52) U.S. Cl. CPC H02J 7/0045; H02J 7/0055; H02J 7/0031; H01M 2/1077; H01M 2/206; H01M 10/482

(57) ABSTRACT

Disclosed is a modular electrical energy storage and supply system configured one or more transportable unit for relocating the system from one site location to another site location. The system includes energy storage modules, energy conversion unit, monitoring and control units, one or more energy storage module interconnection interfaces, and other peripheral electrical components arranged spatially separated, securely enclosed, and uniformly distributed within the one or more transportable unit for facilitating transportation and customization of the system. Further, presented is a differentiated system and method for rapidly deploying energy storage in grid-tied, off-grid, backup or other use cases.

### CROSS REFERENCE TO RELATED APPLICATION

This application claims the benefit of U.S. Provisional Patent Application No. 62/342,928, filed May 28, 2016, and U.S. Provisional Patent Application No. 62/342,963, filed May 29, 2016, the disclosures of which are incorporated by reference herein in their entirety.

### TECHNICAL FIELD OF INVENTION

The present invention relates in general to the field of devices for storing electrical energy, and more particularly the present invention relates to a modular electrical energy storage and supply system that can be conveniently transported from one location to another, and be easily connected or disconnected to an external electrical system, such as a power grid system.

### BACKGROUND

Electricity is the only commodity in the world with no significant storage. This at times raises a challenge for electric power system operators, such as electric distribution utilities, regional transmission organizations (RTOs), independent system operators (ISOs) and others to constantly maintain a real-time balance between electricity supply and demand. As a result, the electric grid infrastructure is built to handle peak electricity demand hours within a year which happen occasionally and for short periods of times.

In the past, several electrical energy storage systems existed, but there have been problems with such energy storage systems. Firstly, such systems' costs remain very high. Secondly, although such energy storage systems are able to provide tens of services, the services are divided amongst varying stakeholder groups, namely customer services, utility services and the ISOs/RTOs services. As a result, such energy storage systems are only able to generate limited revenue, and thus may not be economically viable to continue their uses for a long term.

Further, prior existing large-scale energy storage and conversion systems intended for storing and generating electricity for utility-scale, and commercial and industrial (C&I) applications have been stationary in nature, as a result they are only deployable at a specific location connected to one point on an electric grid. Such systems can only generate revenues from the limited amount of services they can offer due to their immobility. Further, installation of such stationary systems raises a big financial risk, as the services provided by such stationary systems might not be needed for the lifetime of the asset. For example, in a Transmission and Distribution (T&D) upgrade deferral applications, such energy storage systems might be needed for no more than 2 to 3 years, while the asset can have a lifetime of 10 years. Thus, when such stationary energy storage systems are deployed for T&D applications, this will result in losing the financial value of 7-8 years of the useful life of the equipment. Further, another issue with such energy storage systems that remains unsolved is their non-customizable scalability in terms of energy and power rating, making them unsuitable for many specific applications.

Furthermore, some inventors did envision, and proposed containerized electrical energy storage systems in the past that may facilitate transportation, but such systems are not convenient for use due to their sizes and bulkiness which require use of cranes, forklifts or the like machinery to load or unload the systems which adds additional time and burden for relocation of the system.

Thus, in the light of above discussion, it should be evident that there remains a need for a transportable electric energy storage system that may be cost effective and offer key benefits for utilities, customers and other grid operators. More particularly, there remains a need for an energy storage system that would overcome the shortcomings of the background arts discussed above.

The proposed electrical energy storage and supply system solves the above discussed problems in multiple ways. The proposed system is cost effective as it makes use of one or more energy storage units, such as second life batteries reducing the cost of overall system significantly. Next, the proposed system for storage and supply of electrical energy is configured on a transportable unit that can be conveniently transported from one location to other and can be connected or disconnected to and from an external electrical system, such as a power grid system. Next, the system offers customizable scalability, which is required to address a wide range of applications. Next, the system offers modularity, which can ease in exchange, upgrade and expansion of system components as and when needed to meet fluctuating requirements for various applications.

### BRIEF SUMMARY

It is an objective of the present invention to provide a modular electrical energy storage and supply system configured on a transportable unit for relocating the system from one site location to another site location.

It is another main objective of the present invention to provide a differentiated system and method for rapidly deploying energy storage in grid-tied, off-grid, backup or other use cases.

According to an aspect of the present invention there is provided a modular electrical energy storage and supply system configured on at least one transportable unit for relocating the system from one site location to another site location. The system includes one or more energy storage modules configured for storing energy of desired rating, each of the one or more energy storage modules including one or more rechargeable energy storage cells operably coupled to a cell monitoring and control unit, wherein the cell monitoring and control unit is configured to monitor, and control the one or more rechargeable energy storage cells; at least one energy conversion unit operably coupled with the one or more energy storage modules through one or more energy storage module interconnection interfaces for receiving, and converting the energy generated by the one or more energy storage modules in a form that can be input to an external electrical system via one or more site interconnect points associated therewith; one or more monitoring and control units operably coupled with the one or more energy storage modules, the at least one energy conversion unit, and the one or more energy storage module interconnection interfaces for monitoring and controlling the functioning of the system; and a communication interface module configured for enabling the one or more monitoring and control units to communicate with at least one of: a specific site location where the external electrical system is located, and a remote monitoring center.

According to the same aspect, the system further includes one or more energy storage to energy conversion interconnection interfaces for connecting the at least one energy conversion unit with the one or more energy storage modules using the one or more energy storage module interconnection interfaces; and one or more energy conversion unit to site interconnection interfaces for interfacing the at least one energy conversion unit with the one or more site interconnect points.

According to the same aspect, the system further includes one or more auxiliary loads; an auxiliary power unit and controller operably coupled with the one or more auxiliary loads to provide constant supply power, monitoring, control, safety to the one or more auxiliary loads, wherein, the one or more energy storage modules, the at least one energy conversion unit, the one or more monitoring and control units, the one or more energy storage module interconnection interfaces, the one or more energy storage to energy conversion interconnection interfaces, one or more energy conversion unit to site interconnection interfaces, and other peripheral electrical components are all arranged spatially separated, securely enclosed, and uniformly distributed within the at least one transportable unit for facilitating transportation and customization of the system.

According to the same aspect, the at least one transportable unit comprises of a container or a pad.

Additional objects and aspects of the present invention would appear and become clear as the detail description proceeds with the accompanying drawings.

### BRIEF DESCRIPTION OF THE DRAWINGS

The foregoing summary, as well as the following detailed description of preferred embodiments, is better understood when read in conjunction with the appended drawings. There is shown in the drawings example embodiments, however, the application is not limited to the specific system and method disclosed in the drawings.

FIG. 1A-1B illustrates a rear perspective view, and a front perspective view of a transportable electrical energy storage and supply system, in accordance with an exemplary embodiment of the present invention;

FIG. 2 illustrates a front view of the transportable electrical energy storage and supply system, in accordance with an exemplary embodiment of the present invention;

FIG. 3A-3B illustrates a front perspective view, and a back perspective view of a transportable electrical energy storage and supply system, in accordance with another exemplary embodiment of the present invention; and

FIG. 4A-4B illustrates an exemplary block diagram representation of functional components used in the transportable electrical energy storage and supply system, in accordance with an exemplary embodiment of the present invention.

### DETAILED DESCRIPTION

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

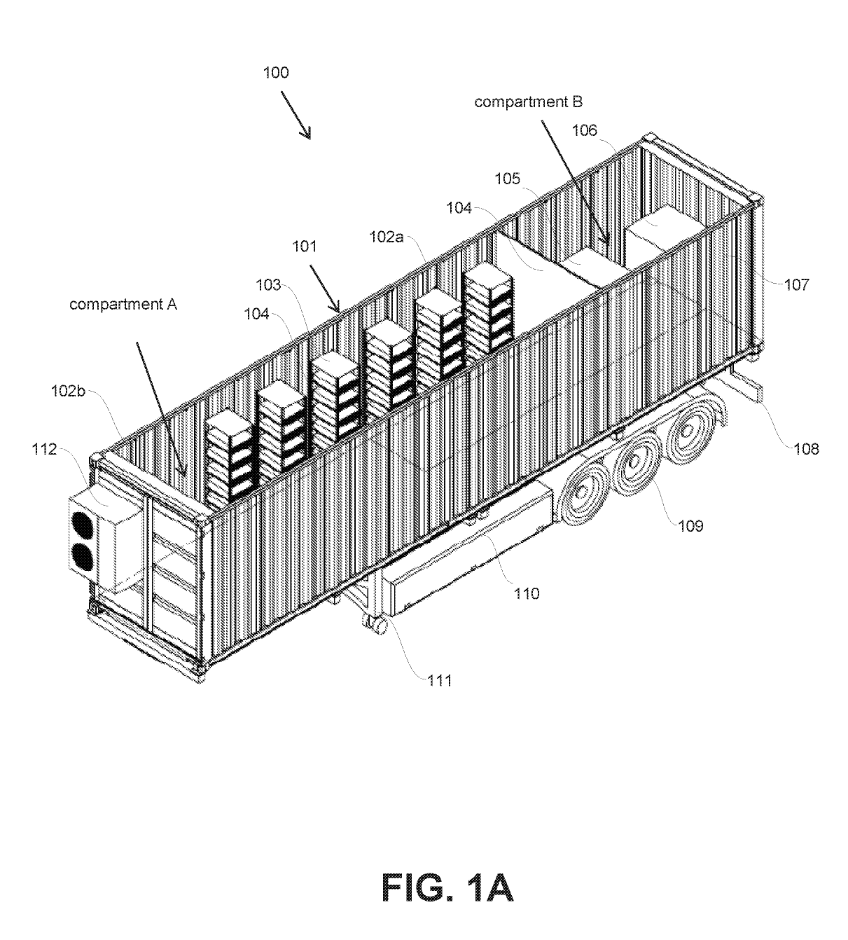

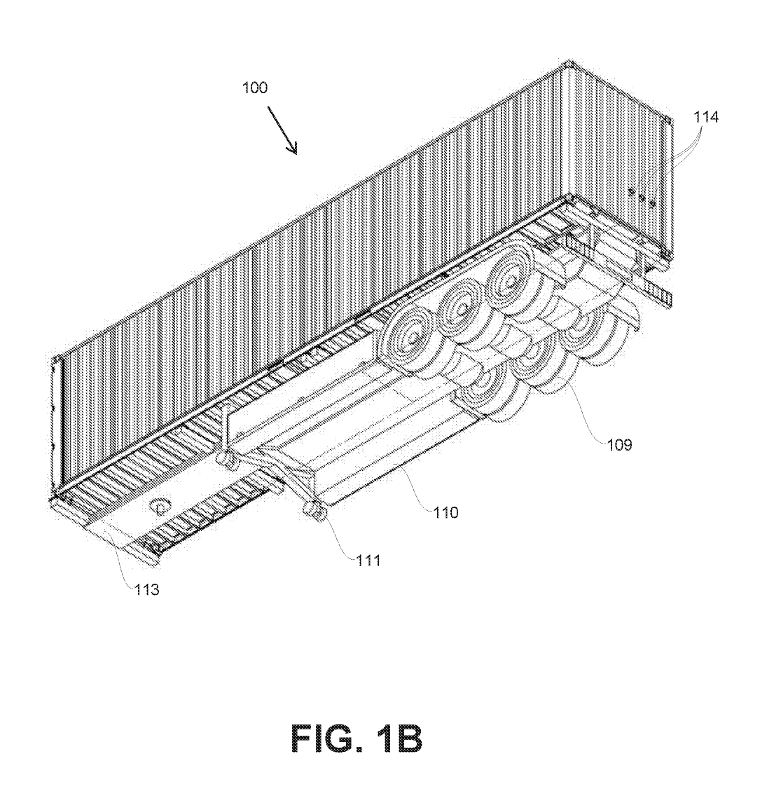

The various features and embodiments of the system and method for modular transportable electrical energy storage and supply system will now be described in conjunction with FIGS. 1-4.

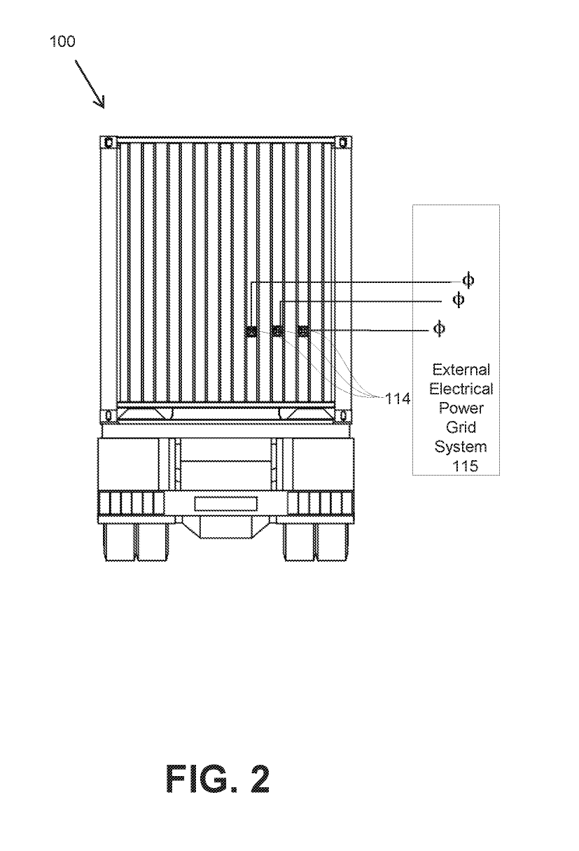

Referring to FIGS. 1A-1B and FIG. 2 that illustrates a rear perspective view, a front perspective view, and a front of a transportable electrical energy storage and supply system respectively, in accordance with an exemplary embodiment of the present invention.

As shown, the electrical energy storage and supply system 100 comprises of at least one transporting unit 101 in the form of a container that may range in length, width and height such as to facilitate accommodation of all the electrical energy storage and supply system related components and provide a sufficient room or space for future customization of the electrical energy storage and supply system by allowing addition of further components. The transporting unit 101 as illustrated is in the form of a container 101, particularly a box-like housing having a body with four side walls, a top wall (not visible) and a bottom wall, all formed of structural elements 102a and enclosure materials 102b preferably rigid in nature which may be coupled to form the container's 101 body and capable of maintaining erection for the container 101. The structural elements 102a and the enclosure materials 102b are selected such as to meet a specific Ingress Protection (IP) and/or National Electrical Manufacturers Association (NEMA) ratings.

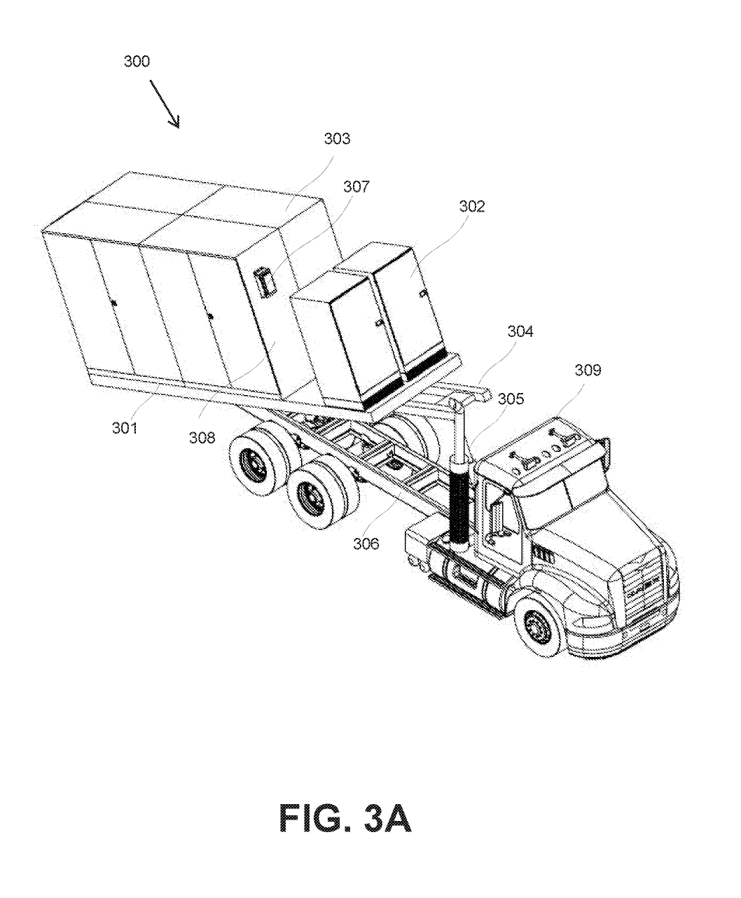

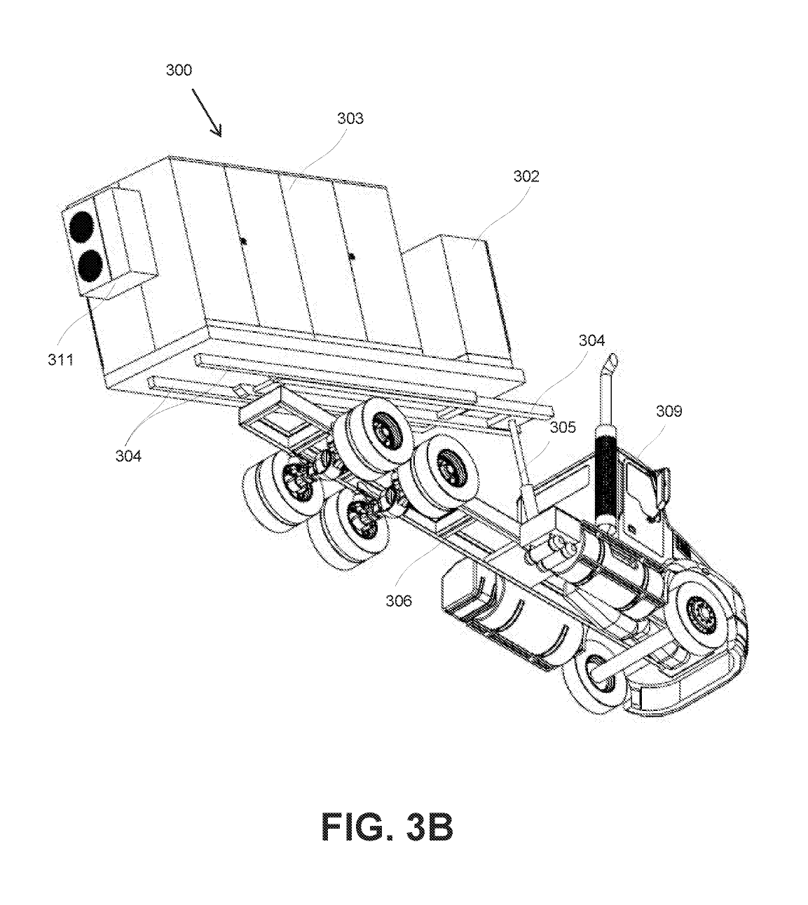

As shown, the container 101 would be provided with one or more access doors 107, or one or more windows or similar openings (not shown). According to the embodiment, the access doors 107 may preferably be provided with one or more access entries enabled with access authenticating means (not shown) to only allow entry for authorized persons. The access authenticating means may be mechanically controlled, electronically controlled or by any other suitable means. According to an example, as best shown with reference to FIG. 3A, the door 308 may have an electronic keypad 307, wherein the person may need to key in authentication credentials in order to be able access interior of the container 101. The authorization credentials may preferably include but not limited to a key code, user IDs, that may contain alphabets, numeral or combination thereof.

Referring back to FIG. 1A-1B, the container 101 is loaded onto a trailer bed 113 with wheels 109 which may then be hauled by a transporting vehicle (not shown) for relocating the container 101 from one site location to another. The container 101 may be made to lift and drop on the trailer bed 113 using some external facilities such as cranes, and may be configured to slide over or roll off over the trailer bed 113 for loading or unloading the container 101 to and from the trailer bed 113. The container 101 may further be provided with one or more spring (not shown), one or more dampers 108 for generation of reactive forces to absorb energy of an impact when the container 101 is dropped-off on the specific site location or unloaded or loaded to and from the trailer bed 113.

The container 101 or the trailer bed 113 may be provided with one or more stands 111 to enable the container 101 to stand on its own at the site location, when not being transported. The stand 111 may preferably be foldable which may be folded while the container 101 is transported. The stand 111 may be provided with additional wheels that may help in hauling the trailer bed 113 or the container 101.

According to the embodiment, the container 101 due to its box like shape and size are capable of being stacked on top of one another, so that multiple containers can be transported from one site location to another site location via the same transporting vehicle. Multiple containers can also be stacked when deployed at a site. It should be understood by those skilled in the art that such stacking can be done using external facilities such as cranes and the like to pick and drop a container on another to form the stack of containers.

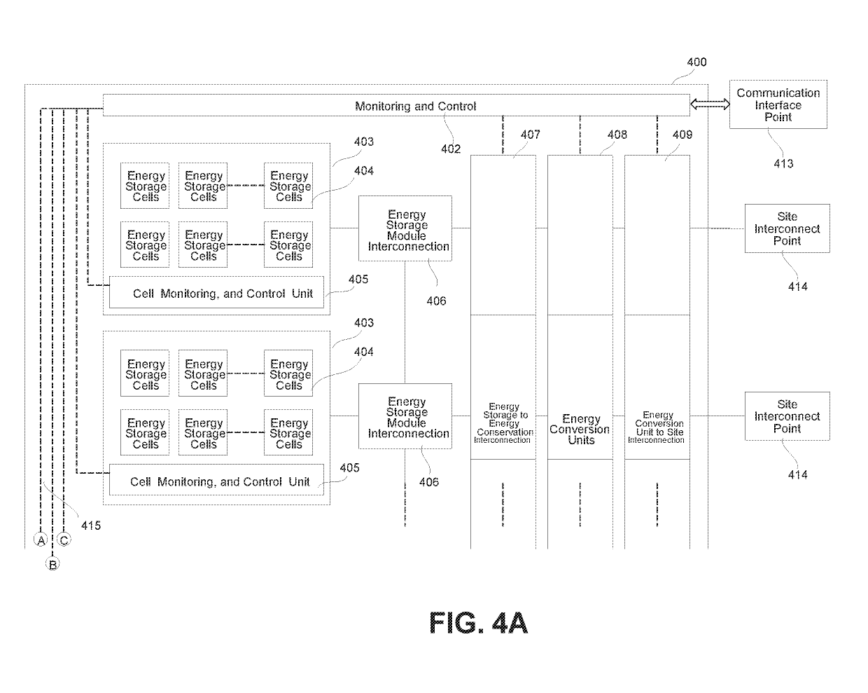

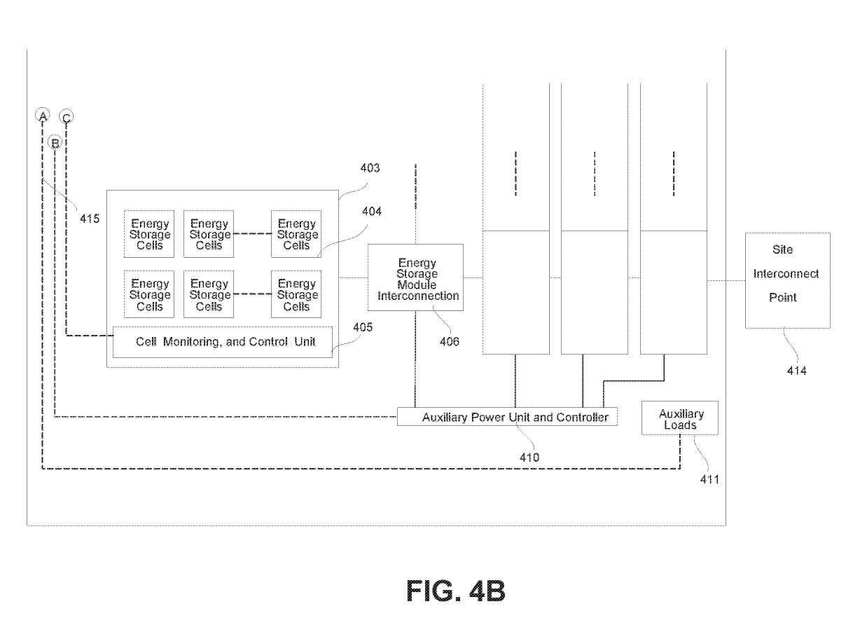

As shown in FIG. 1A, the container 101 may be compartmentalized using one or more separators 104. Although only two compartments, namely compartment A and Compartment B is shown illustrated, it should be understood that any number of compartments may be formed for securely housing one or more energy storage modules 103, and other electrical peripheral associated components 106 (all shown as a single unit) that will be discussed in detail with respect to FIGS. 4A-4B. Such compartmentalization facilitates safer use of system especially during the uses of the energy storage modules 103, and other electrical peripheral components that can vent flammable and/or explosive gases.

The electrical energy storage and supply system 100 of the proposed invention includes the one or more energy storage modules 103 configured for storing energy of desired rating. Each energy storage modules 103 include one or more rechargeable energy storage cells 104. The energy storage cells 104 generally comprises of an anode and a cathode. The cells 104 may comprise an electrolyte and be sealed in a housing as generally known in the art. In some cases, the cells 104 can be stacked to form a battery. The cells 104 can be arranged in parallel, in series, or both in parallel and in series. The rechargeable energy storage cells 104 comprises of but not limited to lithium ion cells, nickel-cadmium cells, fuel cells, flow batteries, metal air batteries, Electric Vehicle (EV) batteries which may be electromechanical or electrochemical in nature. According to a preferred embodiment, the rechargeable energy storage cells may comprise of second life batteries (for example used EV batteries) to keep the cost of overall energy storage system 100 affordable.

According to the embodiment, the rechargeable energy storage cells 104 are operably coupled to a cell monitoring and control unit 105. The cell monitoring and control unit 105 is configured to monitor, and control the rechargeable energy storage cells 104. For example, the cell monitoring and control unit 105 may help move the electricity into and out of the energy storage modules or cells in a controlled manner.

Further, in a broader sense, the peripheral elements 106, all shown as a single unit for simplicity may comprise of at least one energy conversion unit, one or more energy storage module interconnection interfaces, one or more monitoring and control units, a communication interface module, one or more energy storage to energy conversion interconnection interfaces, one or more energy conversion unit to site interconnection interfaces as described in detail in FIG. 4A-4B below. Further, the container 101 may have one or more auxiliary loads associated with it. An auxiliary power unit and controller for controlling the functionalities of the auxiliary loads, as more fully detailed in FIG. 4A-4B. The auxiliary loads associated with the container 101 may comprise of lightings, and/or a Heating, Ventilation and Air Conditioning (HVAC) system 112 as shown. Further, the auxiliary loads may also be present outside the container or at the site location where the system 100 is deployed.

Further, as shown in FIG. 1A, the energy storage modules 103, the cell monitoring and control unit 105, and the peripheral elements 106 may be arranged spatially separated, securely enclosed, and uniformly distributed within the container 101 for facilitating transportation and customization of the system 100. Although it is illustrated that the energy storage modules 103, the cell monitoring and control unit 105, and the peripheral elements 106 are all arranged spatially separated, securely enclosed, and uniformly distributed within one container 101, it is possible to configure the energy storage modules 103, the cell monitoring and control unit 105, and the peripheral elements 106 into multiple different containers which can then be transported to the desired site location for use. The secure enclosure may be in the form of cabinets for example, the cell monitoring and control unit 105 may be securely enclosed in the form of a cabinet. The spatial arrangement of the energy storage modules 103, the cell monitoring and control unit 105, and the peripheral elements 106 will be such as to enable up-gradation or customization of the system by allowing addition of further components as the need arises. The energy storage modules 103, the cell monitoring and control unit 105, and the peripheral elements 106 are all configured or engineered inside the container 101 in a way to withstand any jerks, or angled inclinations during travel, and loading and/or unloading of the transportable unit to and from a transporting vehicle.

The system 100 may be further configured to have one or more heat pipes for circulating a refrigerant within the container 101 to keep an internal environment within the container 101 optimum and safe, one or more phase-changing material boards for increased heat transfer out of the container 101, a plurality of fiber-optic cables configured within the container 101 for spark detection, and one or more isolated compartments configured within the container 101 for mitigating any risk from fire (this can limit possible fire from spreading to rest parts of the container 101), all of these help in regulating or managing proper environmental condition within the container 101 and keep the system secure and operational. Besides this, the system 100 may deploy the Heating, Ventilation and Air Conditioning (HVAC) system 112 for regulating the environment whitish the container 101 or cabinet enclosures housing various components.

Further, the container 101 or the cabinet enclosures of the proposed invention may be High-Altitude Electromagnetic Pulse (HEMP) hardened to protect the energy storage modules 103, the cell monitoring and control unit 105, and the peripheral elements 106 or any other components from an instantaneous, intense electromagnetic energy field that can overload the electrical system forming the part of the energy storage modules 103, the cell monitoring and control unit 105, and the peripheral elements 106 or any other components and prevent any electromagnetic energy field originating and going out of the system The HEMP may rise from uses of various nuclear devices or non-nuclear devices such as powerful batteries or reactive chemicals. According to the embodiment, the hardening against the HEMP is provided by applying additional protective layers of materials throughout inside surfaces of the container 101, or the sides and top of the cabinet enclosures. The protective layers of materials may preferably include but not limited to fine copper and aluminum or galvanized steel.

Further, for increased safety during transportation of the electrical storage system 100, the energy storage modules 103 in the container 101 might be mechanically disconnected from each other once the container is moved onto the trailer bed 113. This can either be done manually or automatically by placing the container on a latch which is connected to a mechanical switch. The container 101 may further be provided with one or more site interconnect points or plug and play terminals 114 associated therewith for connecting the system with an external electrical system for example, but not limited to external electrical power grid system 115 as shown in FIG. 2.

The container 101 may further deploy additional storage compartment or a tool box 110, which may optionally interconnect with the container 101 or be made a part of the trailer 113. The storage compartments or tool box 110 can securely house several equipment during transportation, which can be easily deployed once the system 100 is ready for installation or connected at the destined site location.

According to some embodiments, the system 100 or container 101 may further be equipped with fiber-optic communication panels that may enable sending and receiving data in areas where user might need to transmit data quickly to achieve short reaction times. The fiber-optic communication panels may preferably be used in areas where cybersecurity is an issue

FIG. 3A-3B illustrates a front perspective view and a back perspective view of a transportable electrical energy storage and supply system, in accordance with another exemplary embodiment of the present invention. In particular, the FIG. 3A-3B show an alternative form of the transportable unit in a pad 301 form and configuration of energy storage modules 303, cell monitoring and control unit, peripheral elements, and other components, all shown configured as a single unit 302 spatially separated, securely enclosed, and uniformly distributed on the pad 301 for facilitating transportation and customization of the system 300. Although it is illustrated that the energy storage modules 303, the cell monitoring and control unit, peripheral elements, and other components, all shown configured as a single unit 302 spatially separated, securely enclosed, and uniformly distributed on the pad 301, it is possible to configure the energy storage modules 303, the cell monitoring and control unit, peripheral elements, and other components into multiple different pads which can then be transported to the desired site location for use.

Unlike the transportable unit, particularly the container 101 discussed above with reference to FIGS. 1A-1B, the pad 301 may not be in the box form. Referring to FIGS. 3A-3B in conjunction with FIGS. 1A-1B, the pad 301 may be formed using structural elements 102a, and will essentially employ all the features discussed above in relation to the containerized form 101 of the transportable unit. Importantly, the pad 301 form of the transportable unit when deployed can more easily slide off using a provision 304 (a track mechanism) that may be a part of trailer bed 306 that can be hauled by a transporting vehicle 309. The sliding feature of the pad 301 over the track mechanism 304 may be facilitated by a hydraulic mechanism 305 that may again be a part of the transporting vehicle 309.

Referring to FIG. 4A-4B that illustrates an exemplary block diagram representation of functional components used in the transportable electrical energy storage and supply system, in accordance with an exemplary embodiment of the present invention.

As shown, the system 400 includes one or more energy storage modules 403 configured for storing energy of desired rating as may be required for external electrical utilities related to grid owners or non-grid users. Each of storage modules 403 includes one or more rechargeable energy storage cells 404 operably coupled to a cell monitoring and control unit 405. The rechargeable energy storage cells 404 comprise of one of lithium ion cells, nickel-cadmium cells, fuel cells, flow batteries, metal air batteries, and Electric Vehicle (EV) batteries. According to an embodiment, the rechargeable energy storage cells comprise of second life batteries.

The cell monitoring and control unit 405 is configured to monitor, and control the rechargeable energy storage cells 404. For example, the cell monitoring and control unit 405 may help move the electricity into and out of the energy storage modules 403 or cells 404 in a controlled manner.

The electric energy storage and supply system 400 further includes other peripheral element or components such as at least one energy conversion unit 408, energy storage module interconnection interfaces 406, energy storage to energy conversion interconnection interfaces 407, energy conversion unit to site interconnection interfaces 409, one or more monitoring and control units 402, auxiliary loads 411, an auxiliary power unit and controller 410.

The energy conversion unit 408 is operably coupled with the energy storage modules 403 through one or more energy storage module interconnection interfaces 406 for receiving, and converting the energy generated by the energy storage modules 403 in a form that can be an input to an external electrical system (such as grid system or electrical system for public use) via one or more site interconnect points 414 associated with the system.

The energy conversion unit 408 is functional to covert Direct Current (DC) to an Alternating Current (AC) or vice versa. Typically, electricity from energy storage modules 403 is in Direct Current (DC) form. However, many external electrical grids operate with Alternating Current (AC) as input, thus, to meet this requirement; the energy conversion unit 408 converts DC to AC. The energy conversion unit 408 is typically bidirectional to do the conversion two ways from DC to AC or AC to DC. The energy conversion unit 408 may need to convert AC energy to DC energy while charging the energy storage modules 403, and may need to perform DC energy to AC energy conversion while discharging the energy storage modules 403. However, it should be understood by those skilled in the art that it is possible to use energy conversion unit 408 unidirectional in nature dedicated for only charging or for only discharging. Such uses may raise the need of employing multiple energy conversion units 408. Further, each of the energy storage modules 403 is interconnected using the one or more energy storage module interconnection interfaces 406 for safety and protection.

The energy storage to energy conversion interconnection interfaces 407 is used for connecting the energy conversion unit 408 with the energy storage modules 403 using the one or more energy storage module interconnection interfaces 406, and the energy conversion unit to site interconnection interfaces 409 is used for interfacing the energy conversion unit 408 with the one or more site interconnect points 414 which connects the energy stored in the energy storage modules 403 as an input to an external electrical system such as power grid systems. The energy storage to energy conversion interconnection interfaces 407, the energy storage module interconnection interfaces 406, and the energy conversion unit to site interconnection interfaces 409 comprises of one or more fuses, one or more meters, one or more disconnects, one or more relays, one or more switchgears and other electrical components known in the art. It is understood that the functionality of such components are well known and hence the same is not detailed in this disclosure.

The monitoring and control units 402 is operably coupled with the energy storage modules 403, the energy conversion unit 408, and the energy storage module interconnection interfaces 406, the energy storage to energy conversion interconnection interfaces 407, the energy conversion unit to site interconnection interfaces 409 for monitoring and controlling the functioning of the system.

The auxiliary loads 411 comprise of loads associated with the transportable unit such as lightings, and/or a Heating, Ventilation and Air Conditioning (HVAC) system that may be attached to the transportable unit. Further, the auxiliary loads may be present outside the transportable unit or at the site location where the system is deployed. The auxiliary power unit and controller 410 is operably coupled with the auxiliary loads 411 to provide constant supply power, monitoring, control, safety to the one or more auxiliary loads 411.

The electrical energy storage and supply system 400 further includes a communication interface module 413 configured for enabling the monitoring and control units 402 to communicate with at least one of: a specific site location where the external electrical system is located, and a remote monitoring center.

According to an embodiment of the present invention, the modular electrical energy storage and supply system is further enabled with Waveguide-Below-Cutoff (WBC) protection for protecting functionalities of the energy storage modules 403, and all other peripheral components, all configured on the at least one transportable unit (at least one container 101 or at least one pad 301). Typically, the energy storage modules 403, and all other peripheral components discussed above are encapsulated in the form of metal shields capable of restricting the electromagnetic signals and interference of a particular frequencies to penetrate and enter and disrupt the electrical/electronic components against any effect from such frequencies.

As shown illustrated in dotted form, the signal lines 415 are used to carry signals, messages, telemetry or the like between the different systems elements discussed above.

In the foregoing description, certain terms have been used for brevity, clearness, and understanding. No unnecessary limitations are to be implied there from beyond the requirement of the prior art because such terms are used for descriptive purposes and are intended to be broadly construed. Therefore, the disclosure is not limited to the specific details, the representative embodiments, and illustrative examples shown and described. Thus, this application is intended to embrace alterations, modifications, and variations that fall within the scope of the current disclosure

We claim:

1. A modular electrical energy storage and supply system configured on at least one transportable unit for relocating the system from one site location to another site location, comprising:
one or more energy storage modules configured for storing energy of desired rating, each of the one or more energy storage modules includes one or more rechargeable energy storage cells operably coupled to a cell monitoring and control unit, wherein the cell monitoring and control unities configured to monitor, and control the one or more rechargeable energy storage cells;
at least one energy conversion unit operably coupled with the one or more energy storage modules through one or more energy storage module interconnection interfaces for receiving, and converting the energy generated by the one or more energy storage modules in a form that can be an input to an external electrical system via one or more site interconnect points associated therewith;
one or more monitoring and control units operably coupled with the one or more energy storage modules, the at least one energy conversion unit, and the one or more energy storage module interconnection interfaces for monitoring and controlling the functioning of the system; and
a communication interface module configured for enabling the one or more monitoring and control units to communicate with at least one of: a specific site location where the external electrical system is located, and a remote monitoring center.
Wherein, the one or more energy storage modules, the at least one energy conversion unit, the one or more monitoring and control units, the one or more energy storage module interconnection interfaces are arranged spatially separated, securely enclosed, and uniformly distributed within the at least one transportable unit for facilitating transportation and customization of the system.

2. The modular electrical energy storage and supply system of claim 1, wherein the at least one transportable unit comprises at least one of a container, and a pad.

3. The modular electrical energy storage and supply system of claim 1, wherein rechargeable energy storage cells comprises one of lithium ion cells, nickel-cadmium cells, fuel cells, flow batteries, metal air batteries, Electric Vehicle (EV) batteries.

4. The modular electrical energy storage and supply system of claim 1, wherein the rechargeable energy storage cells comprises of second life batteries.

5. The modular electrical energy storage and supply system of claim 1, wherein each of the plurality of energy storage modules are interconnected using the one or more energy storage module interconnection interfaces.

6. The modular electrical energy storage and supply system of claim 1 further comprising:
one or more energy storage to energy conversion interconnection interfaces for connecting the at least one energy conversion unit with the one or more energy storage modules using the one or more energy storage module interconnection interfaces; and
one or more energy conversion unit to site interconnection interfaces for interfacing the at least one energy conversion unit with the one or more site interconnect points.

7. The modular electrical energy storage and supply system of claim 6, wherein the one or more energy storage to energy conversion interconnection interfaces, the one or more energy storage module interconnection interfaces, and the one or more energy conversion unit to site interconnection interfaces comprises of one or more fuses, one or more meters, one or more disconnects, one or more relays, one or more switchgears.

8. The modular electrical energy storage and supply system of claim 1, wherein the one or more monitoring and control units is further operably coupled to the one or more energy storage to energy conversion interconnection interfaces, and one or more energy conversion unit to site interconnection interfaces for monitoring and controlling the functioning of the one or more energy storage to energy conversion interconnection interfaces, and one or more energy conversion unit to site interconnection interfaces.

9. The modular electrical energy storage and supply system of claim 1 further comprising:
one or more auxiliary loads; and
an auxiliary power unit and controller operably coupled with the one or more auxiliary loads to provide constant supply power, monitoring, control, safety to the one or more auxiliary loads.

10. The modular electrical energy storage and supply system of claim 1, wherein the one or more auxiliary loads comprises of one or more lights, a Heating, Ventilation and Air Conditioning (HVAC) system.

11. The modular electrical energy storage and supply system of claim 1 further comprising:
one or more heat pipes for circulating a refrigerant within the at least one transportable unit to keep an internal environment within the transportable unit optimum and safe;
one or more phase-changing material boards for increased heat transfer out of the at least one transportable unit;
a plurality of fiber-optic cables configured within the at least one transportable unit for spark detection;
one or more isolated compartments configured within the at least one transportable unit for mitigating any risk from fire; and
a latch switch for disconnecting each of the one or more energy storage modules from one another during transportation.

12. The modular electrical energy storage and supply system of claim 1, wherein the at least one transportable unit is constructed in a modular manner to facilitate customization of stored energy from the system.

13. The modular electrical energy storage and supply system of claim 1,wherein the one or more energy storage modules, the at least one energy conversion unit, the one or more monitoring and control units, the one or more energy storage module interconnection interfaces, the one or more energy storage to energy conversion interconnection interfaces, the one or more energy conversion unit to site interconnection interfaces are configured on the at least one transportable unit in a way to withstand jerks, or angled inclinations during travel, and loading and/or unloading of the at least one transportable unit to and from a transporting vehicle.

14. The modular electrical energy storage and supply system of claim 2, wherein the container is stackable on top of another container.

15. The modular electrical energy storage and supply system of claim 1, wherein the at least one transportable unit is facilitated by a provision provided on the transporting vehicle for ease of loading and/or unloading the at least one transportable unit to and from the transporting vehicle.

16. The modular electrical energy storage and supply system of claim 1, wherein the at least one transportable unit further comprises of one or more spring, one or more dampers for generation of reactive forces to absorb energy of an impact when the at least one transportable unit is dropped-off on the specific site location.

17. The modular electrical energy storage and supply system of claim 1, wherein the at least one transportable unit is configured using structural elements and enclosure materials to meet a specific Ingress Protection (IP) and/or National Electrical Manufacturers Association (NEMA) ratings.

18. The modular electrical energy storage and supply system of claim 1, wherein the at least one transportable unit is provided with one or more access entries enabled with access authenticating means to only allow entry for authorized persons.

19. The modular electrical energy storage and supply system of claim 1 further comprising Waveguide-Below-Cutoff (WBC) protection unit for protecting functionalities of the one or more energy storage modules, the at least one energy conversion unit, the one or more monitoring and control units, the one or more energy storage module interconnection interfaces, the one or more energy storage to energy conversion interconnection interfaces, the one or more energy conversion unit to site interconnection interfaces, the auxiliary power unit and controller, the one or more auxiliary loads all configured on the at least one transportable unit.

20. The modular electrical energy storage and supply system of claim 1, wherein the transportable unit is High-Altitude Electromagnetic Pulse (HEMP) hardened.
